(19) United States
(12) Patent Application Publication
(10) Pub. No.: US 2026/0094586 A1
(43) Pub. Date: Apr. 2, 2026

(54) MULTI-CLASS AUDIO SOURCE SEPARATION USING NEURAL NETWORKS

(71) Applicant: Adobe Inc., San Jose, CA (US)

(72) Inventors: Jiaqi SU, San Francisco, CA (US); Zeyu JIN, San Francisco, CA (US); Ke CHEN, San Diego, CA (US)

(73) Assignee: Adobe Inc., San Jose, CA (US)

(21) Appl. No.: 18/900,325

(22) Filed: Sep. 27, 2024

(51) Int. Cl. G10H 1/00

(52) U.S. Cl. CPC G10H 1/0025; G10H 2220/106; G10H 2250/311

(57) ABSTRACT

Embodiments are disclosed for a process of separating and enhancing audio sound events from an audio sequence. The method may include receiving an audio sequence and a first audio event identifier, the first audio event identifier indicating a requested first audio event type of a plurality of audio event types. The method may further comprise processing an audio spectrogram representation of the audio sequence through a trained encoder-decoder network to generate a first modified audio spectrogram, the first modified audio spectrogram representing audio of the requested first audio event type. The method may further comprise generating an output using the first modified audio spectrogram.

### BACKGROUND

Audio source separation is a fundamental audio task that aims to extract individual sound sources from a complex audio mixture. Audio source separation can encompass several subtasks, each focusing on separating specific types of sources, such as music source separation (e.g., vocals, drums, bass, etc.), audio event source separation (e.g., applause, engine, etc.), as well as speech separation. The presence of noise, interference, and other audio events within the source audio sequence can pose significant challenges in achieving accurate and clear separation.

### SUMMARY

Introduced here are techniques/technologies that allow an audio separation system to separate audio events from an audio sequence that includes a mixture of speech and/or non-speech audio events.

More specifically, in one or more embodiments, an audio separation system is trained to separate audio events from audio sequences, where the audio events can include speech audio and/or non-speech audio. Some examples of non-speech audio event types that can be separated from an audio sequence include alarm, applause, birds, coughing, crying, engine, laughter, pets, traffic, and typing. Other examples of non-speech audio event types can include reverberation, ambient noise, and music. Upon receiving an audio sequence and an event identifier indicating a speech audio event or a type or class of audio event, the audio separation system processes the audio sequence through a pipeline of neural networks. The pipeline of neural networks can include an encoder-decoder network trained to generate an audio sequence that includes the type of audio event specified by the event identifier, and a post-processing network trained to perceptually enhance the audio of the separated audio event. The audio separation system can process the received audio sequence multiple times with different event identifiers, resulting in separate audio sequences or tracks for each audio event type. Once separated, the audio separation system can further allow a user to selectively include or exclude the separated audio events in a final output audio sequence.

In another embodiment, the audio separation system receives an audio sequence and processes the audio sequence through the pipeline of neural networks to perform a multi-event separation of the audio events. In such embodiments, the encoder-decoder network is trained to separate an audio sequence into a plurality of output tracks simultaneously, where each of the plurality of output tracks is one of a plurality of different audio event types (e.g., speech and/or non-speech).

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of separating audio events from an audio sequence in accordance with one or more embodiments;

FIG. 2 illustrates diagrams of neural networks used by the audio separation system in accordance with one or more embodiments;

FIG. 3 illustrates a diagram of a neural network module in accordance with one or more embodiments;

FIG. 4 illustrates a diagram of a process of training machine learning models to separate multiple classes of audio events from an audio sequence in accordance with one or more embodiments;

FIG. 5 illustrates a diagram of a process of generating a simulated dataset of training audio sequences in accordance with one or more embodiments;

FIG. 6 illustrates a diagram of a process of a multi-event separation of audio events from an audio sequence in accordance with one or more embodiments;

FIG. 7 illustrates a diagram of a process of training machine learning models to perform a multi-event separation of multiple classes of audio events from an audio sequence in accordance with one or more embodiments;

FIG. 8 illustrates a schematic diagram of an audio separation system in accordance with one or more embodiments;

FIG. 9 illustrates a flowchart of a series of acts in a method of separating audio events from an audio sequence in accordance with one or more embodiments;

FIG. 10 illustrates a flowchart of a series of acts in a method of training machine learning models to separate audio events from an audio sequence in accordance with one or more embodiments;

FIG. 11 illustrates a flowchart of a series of acts in a method of performing multi-event separation of audio events from an audio sequence in accordance with one or more embodiments; and

FIG. 12 illustrates a block diagram of an exemplary computing device in accordance with one or more embodiments.

### DETAILED DESCRIPTION

One or more embodiments of the present disclosure include an audio separation system for separating audio events from an audio sequence that includes speech and/or non-speech audio events. Existing techniques for audio separation are inadequate for handling as they are not able to handle the complexity inherent to real world audio. For example, in some music source separation techniques, musical instruments are typically mixed under studio-quality conditions for production, making them inadequate for handling real world audio mixtures that can include reverberations, background noises, and multiple sound events, which each may include reverb and noise overlapping with the speech signal. Other existing techniques are directed only to separating sound events from an audio sequence and are inadequate for situations where some non-speech sound events are desired in a final output audio mixture.

To address these and other deficiencies in conventional systems, the audio separation system of the present disclosure utilizes a pipeline of neural networks trained to separate multiple classes or types of audio events from an audio sequence that contains speech audio and/or non-speech audio. In some embodiments, the audio separation system uses a trained encoder-decoder network to separate out a modified audio sequence that includes a type of audio event specified by an event identifier. In other embodiments, the audio separation system uses a trained encoder-decoder network to simultaneously, or serially, separate out a plurality of modified audio sequences, where each of the plurality of modified audio sequences is a type of audio event the encoder-decoder network has been trained to separate. The audio separation system then uses a trained post-processing network to perceptually enhance the audio of the modified audio sequence. The neural networks are trained using a simulated audio datasets that more closely match real world audio mixtures. For example, the simulated dataset includes audio sequences that are a mixture of non-speech audio events and reverberant speech sounds, which are clean speech sounds convolved with room impulse responses.

The audio separation system of the present disclosure presents improved separation of audio events from an audio sequence, while addressing the limitations of the existing techniques. One advantage of the audio separation system of the present disclosure is the ability to distinguish and separate different types of non-speech sound events from an audio mixture. The audio separation system can therefore produce more useful outputs. For example, some non-speech sound events may be desirable in an audio mixture for a comedy show (e.g., laughter or applause), while other non-speech sound events (e.g., coughing) may be undesirable. The ability of the audio separation system to distinguish each sound event (e.g., both speech and non-speech) into a separate audio sequence or track can allow for the inclusion of desirable non-speech sound events and the exclusion of undesirable non-speech sound events in a final output audio mixture. Another advantage of the audio separation system is the processing of the separated audio sequences through a post-processing network that enhances the quality of the separated audio sequences.

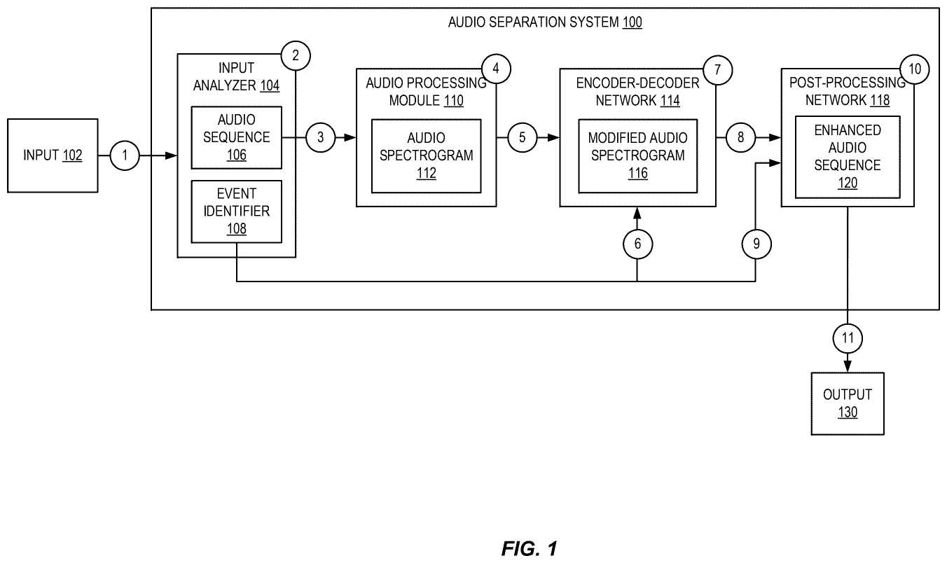

FIG. 1 illustrates a diagram of a process of separating audio events from an audio sequence in accordance with one or more embodiments. As shown in FIG. 1, an audio separation system 100 receives an input 102, as shown at numeral 1. For example, the audio separation system 100 receives the input 102 from a user via a computing device or from a memory or storage location, where the input 102 includes at least an audio sequence (e.g., audio sequence 106). The audio sequence 106 can be an audio waveform that is a mixture of various events (e.g., speech, non-speech audio events, etc.). In one or more embodiments, the input 102 further includes an event identifier 108 indicating a type of audio event being requested for separation in the audio sequence 106. The audio event can be a speech audio event or a non-speech audio event. In one embodiment, example non-speech audio event types include alarm, applause, birds, coughing, crying, engine, laughter, pets, traffic, and typing. Other types of non-speech audio event types can include reverberation, ambient noise, and music. Other embodiments can include fewer, additional, and/or different speech and non-speech audio event types. In some embodiments, the audio sequence 106 and the event identifier 108 can be received in a single input 102 or in multiple inputs. For example, the event identifier 108 can be provided through a selection of one or more audio event types (e.g., from a menu or selectable list). In one or more embodiments, the input 102 can be provided in a graphical user interface (GUI). For example, the audio sequence 106 can be provided to the audio separation system 100, or a user can indicate a storage location (e.g., on a computing device) or a URL to a location storing the audio sequence 106.

In one or more embodiments, the audio separation system 100 includes an input analyzer 104 that receives the input 102. In some embodiments, the input analyzer 104 is configured to extract the audio sequence 106 and the event identifier 108 from the input 102, at numeral 2. The input analyzer 104 then sends the audio sequence 106 to an audio processing module 110, as shown at numeral 3. In one or more embodiments, the audio processing module 110 generates an audio spectrogram 112 representing the audio sequence 106, at numeral 4. The audio spectrogram 112 is a representation of the spectrum of frequencies in an audio signal over time. In one or more embodiments, the audio processing module 110 computes the audio spectrogram 112 representing the audio sequence 106 using a short-time Fourier transform (STFT). The audio spectrogram 112 is then sent to an encoder-decoder network 114, as shown at numeral 5. In one or more embodiments, the event identifier 108 is also sent to the encoder-decoder network 114, as shown at numeral 6.

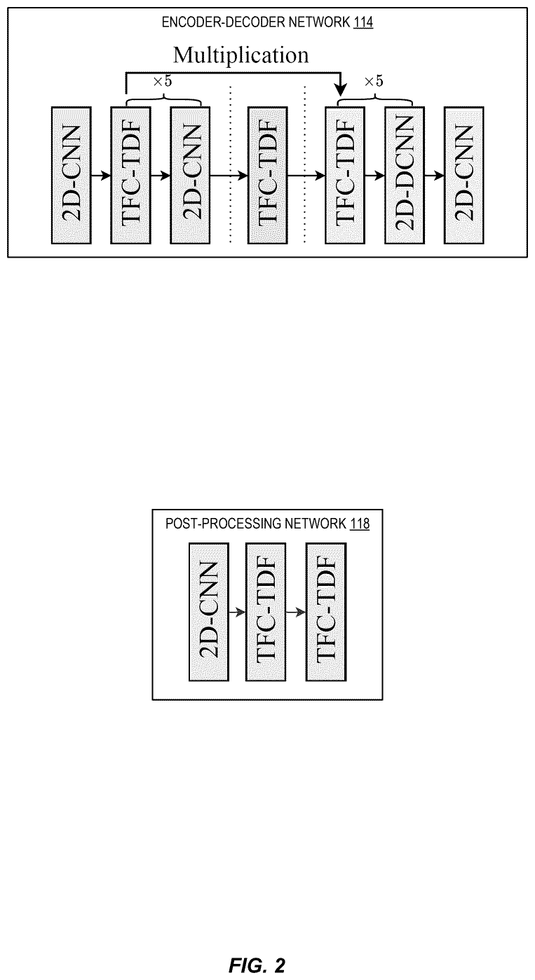

In one or more embodiments, the encoder-decoder network 114 processes the audio spectrogram 112 and the event identifier 108 to generate a modified audio spectrogram 116, at numeral 7. In one or more embodiments, the encoder-decoder network 114 is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. FIG. 2 illustrates diagrams of neural networks used by the audio separation system in accordance with one or more embodiments.

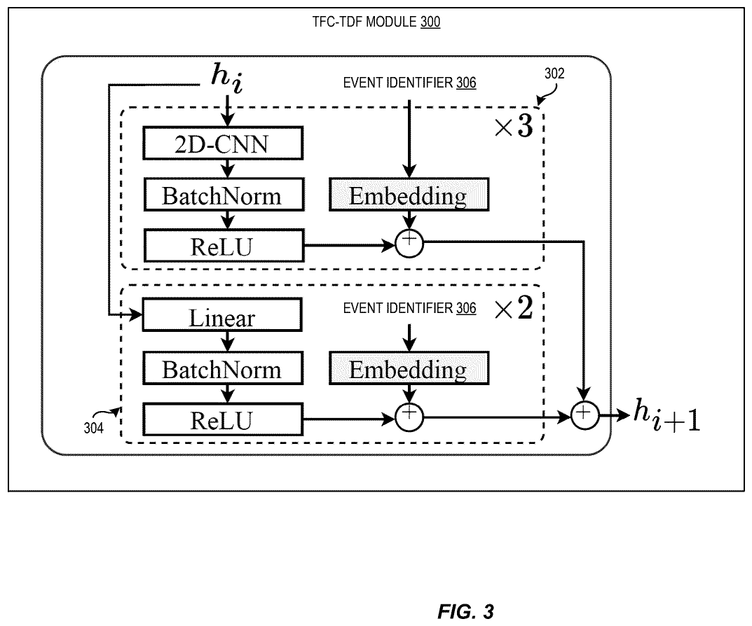

As illustrated in FIG. 2, an encoder of the encoder-decoder network 114 includes a two-dimensional convolutional neural network (2D-CNN) layer, followed by five groups of Time-Frequency Convolution and Time Distributed Fully-Connected Network (TFC-TDF) modules with 2D-CNN layers in between. This results in a total downsample rate of 25-32, while simultaneously increasing the channel size from 32 to 384. Additional details of the TFC-TDF modules are described with respect to FIG. 3. In one or more embodiments, a TFC-TDF module uses three 2D-CNN modules and two linear modules along the frequency axis. The bottleneck includes a single TFC-TDF module. In one or more embodiments, the decoder of the encoder-decoder network 114 replicates the encoder structure with 2D deconvolution neural network (2D-DCNN) layer for upsampling in between.

In one or more embodiments, the encoder-decoder network 114 takes in the real-imaginary spectrogram (e.g., audio spectrogram 112),

$$X = ( {X}_{real} , {X}_{imag} ) ∈$$

computed from an input mixture waveform x (e.g., audio sequence 106).

In one or more embodiments, the modified audio spectrogram 116 generated by the encoder-decoder network 114 is a representation of the audio sequence 106 with the audio event specified by the event identifier 108 separated from the other speech and/or non-speech audio events. In one or more embodiments, an output two-channel matrix,

$${Y}^{′} = ( {Y}_{real}^{′} , {Y}_{imag}^{′} )$$

represents the real and imaginary components of the modified audio spectrogram 116, from which the separated waveform,

$${y}_{( b )}^{′} ,$$

is obtained. In one or more embodiments, multiplicative skip connections are used between the encoder and the decoder, which can enhance the network's separation capability by masking on audio features of different resolutions.

In one or more embodiments, the process described in numerals 1-7 can be repeated multiple times for different event identifiers to produce a modified audio spectrogram for each specified event identifier.

In some embodiments, the audio separation system 100 includes a post-processing network 118. In such embodiments, the modified audio spectrogram 116 is sent to the post-processing network 118, as shown at numeral 8. In one or more embodiments, the event identifier 108 is also sent to the post-processing network 118, as shown at numeral 9. The post-processing network 118 generates the enhanced audio sequence 120, at numeral 10. In one or more embodiments, the post-processing network 118 is a neural network trained to generate an enhanced audio spectrogram from the modified audio spectrogram 116. As illustrated in FIG. 2, an exemplary post-processing network 118 includes a two-dimensional CNN layer and two TFC-TDF modules.

In one or more embodiments, the post-processing network 118 addresses two issues: (1) a model with limited information pathways may not be able to extract the target audio event consistently and accurately in every time frame, causing errors and artifacts in the separated results; and (2) the training objectives to improve perceptual quality could conflict with the separation goals and introduce significant parameter updates to the separation backbone. To address these issues, the post-processing network 118 refines the separation sketch from the pre-trained separation backbone as

$${y}_{( p )}^{′} .$$

Returning to FIG. 1, after the post-processing network 118 generates the enhanced audio spectrogram, the enhanced audio spectrogram can be used to generate an enhanced audio sequence 120. In some embodiments, the enhanced audio sequence 120 is generated by processing enhanced audio spectrogram generated by the post-processing network 118 through an inverse STFT.

The enhanced audio sequence 120 can be sent as an output 130, as shown at numeral 11. In one or more embodiments, after the process described above in numerals 1-10, the output 130 is sent through a communications channel to the user device or computing device that provided the input, to another computing device associated with the user or another user, or to another system or application.

In one or more embodiments, the process described in numerals 1-10 can be repeated multiple times for different event identifiers to produce an enhanced audio sequence for each specified event identifier. In some embodiments, the audio separation system 100 can provide multiple enhanced audio sequences 120 (e.g., one for each audio event type requested). In some embodiments, the audio separation system 100 can provide each of the enhanced audio sequences 120 for storage (e.g., in a sound library).

In one or more embodiments, the audio separation system 100 can split the audio sequence 106 into a plurality of defined categories, where the categorization of the tracks can be based on the training data used to train the audio separation system 100. In another embodiment, the audio separation system 100 can split the audio sequence 106 into a speech track, a music track, and an ambient noise track, where the ambient noise track can include stationary noise and audio events other than speech and music (e.g., non-speech sound events). In another embodiment, the music and ambient noise tracks can be combined into a single non-speech track, resulting in an output of two tracks: a speech track and the non-speech track. In one or more embodiments, the audio separation system 100 can split the audio sequence 106 into three tracks: a speech track, non-speech sound event tracks, and background noises track. Other example types of audio events that the audio separation system 100 can be trained to output as a track includes natural sounds (e.g., animal sounds, wind, etc.). The audio separation system 100 can provide multiple sound event tracks, each for a different sound event that the audio separation system 100 has been trained to detect and separate.

In other embodiments, the audio separation system 100 can generate a single enhanced audio sequence 120 that is a mixture or combination of the separated audio events. In such embodiments, the audio separation system 100 can display, or otherwise provide, the enhanced audio sequences 120 generated for each of the event identifiers in a GUI. A user can then select one or more of the enhanced audio sequences 120 generated for each of the event identifiers for mixing into a final output audio sequence. In one or more embodiments, the audio separation system 100 enables a user to control the mixing ratios of the enhanced audio sequences 120. For example, the user may select a mix of 100% of a speech track with 50% of a music track, and 20% of an ambience track.

In other embodiments, the audio separation system 100 can generate a single enhanced audio sequence 120 that is a mixture or combination of a subset of the separated audio events. For example, if the audio sequence 106 is a recording of a comedian, some non-speech audio events, such as laugher or applause, may be desirable in a final output audio mixture. In such embodiments, the audio separation system 100 can display information indicating the separated audio events in a GUI with interface elements to enable a user to select one or more of the separated audio events to include in the single enhanced audio sequence 120.

In one or more embodiments, the audio separation system 100 can also generate an additional audio sequence (e.g., a remainder audio sequence or audio track) that includes the remainder of the audio sequence 106 after the various audio events have been separated and/or extracted from the audio sequence 106. In some embodiments, the remainder audio sequence can be generated by subtracting the enhanced audio sequences 120 produced by the audio separation system 100 from the audio sequence 106. The remainder audio sequence can be presented as an output with the enhanced audio sequences 120 for each of the target audio event types.

In one or more embodiments, the remainder audio sequence can be a reverberation tail audio sequence or late reverberation of the reverberant speech audio sequence, which is the residual reverberated sound that occurs after the direct arrival and early reflections of the source sound. In one or more embodiments, the reverberation tail audio sequence is the result of separating out or extracting the speech, non-speech sound events, background noise, and background music. In such embodiments, the audio separation system 100 can include a graphical user interface with interface elements (e.g., buttons, dials, etc.) to allow a user to adjust an amount of reverberant speech to include in a final output audio mixture. In other embodiments, the remainder audio sequence can include additional or different audio (e.g., non-speech audio events the audio separation system 100 has not been trained to separate). For example, the remainder audio sequence can be an ambient noise audio generated by subtracting the speech audio and the background music audio from the audio sequence, or the remainder audio sequence can be a mixture of the audio events in audio sequence that were excluded from the plurality of audio event types the audio separation system 600 is trained to separate.

In one or more embodiments, the audio separation system 100 can perform the separation of audio events to each of the channels of an input audio sequence independently, while maintaining the inter-channel relationships of the channels of the input audio sequence. The audio separation system 100 can preserve the original time signal information in the separation results, such as the phase, timing, amplitude and acoustic properties (e.g., reverb and EQ) of the audio events to be same as in the input audio sequence. For multi-channel audio sequences, this means the inter-channel relationship (e.g., the correlation of occurrence of the same audio event, and the channel differences in phase, arrival time, amplitude and acoustics) are maintained even when the separation is applied to each channel independently. This also allows the perceived locality of the separated sound sources to be consistent with how they sound like in the input audio sequence. In such embodiments, maintaining the inter-channel relationships of the channels of the input audio sequence allows the audio event separation to be used on separate sounds from stereo audio, 5.1-channel surround sound, and all other multi-channel formats. In such embodiments, the resulting separated audio sequences will retain the same auditory locality of all non-speech sounds and speech as the multi-channel input audio sequence.

The maintenance of inter-channel relationships of the channels of the input audio sequence also applies to the remainder audio sequence. For example, the reverberation tail as the remainder can be added to the speech track to give the sense of the space and preserve the locality of the speech sources as in the input audio sequence.

FIG. 3 illustrates a diagram of a neural network module in accordance with one or more embodiments. As illustrated in FIG. 3, a TFC-TDF module 300 includes a Time-Frequency Convolution (TFC) block 302 and a Time Distributed Fully connected layer (TDF) block 304. In one or more embodiments, the TFC block 302 includes densely connected convolutional blocks containing CNN layers, Batch Normalization (BN) and a rectified linear activation function (ReLU). In one or more embodiments, the TDF block 304 includes a linear layer, BN, and a ReLU. In the embodiment depicted in FIG. 3, the TFC-TDF module 300 includes three instances of TFC block 302 and two instances of the TDF block 304. In other embodiments, the TFC-TDF module 300 includes a single TFC block 302 and a single TDF block 304.

In one or more embodiments, an event identifier 306 is embedded into the TFC-TDF module 300 via feature-wise linear modulation (FILM). In one or more embodiments, the event identifier 306 is embedded into each TFC-TDF module illustrated in the encoder-decoder network 114 and the post-processing network 118 illustrated in FIG. 2.

The event identifier 306 is passed through an embedding layer of the TFC block 302 and the TDF block 304 inside the TFC-TDF module 300. In one or more embodiments, the embedding layer generates an event prior (e.g., a vector representation or embedding) that is added to the feature maps before the output of the TFC-TDF module 300. In one or more embodiments, the input, hᵢ, is passed through the TFC block 302 and added with the event prior. Similarly, the input, hᵢ, is passed through the TDF block 304 and added with the event prior. The outputs of the TFC block 302 and the TDF block 304 are then added and provided as an output, hᵢ₊₁.

In embodiments where the audio separation system 100 performs multi-event separation, the event identifier 306 is not embedded into the TFC-TDF module 300. In such embodiments, the input, hᵢ, is passed separately through the TFC block 302 and the TDF block 304. The outputs of the TFC block 302 and the TDF block 304 are then added and provided as an output, hᵢ₊₁.

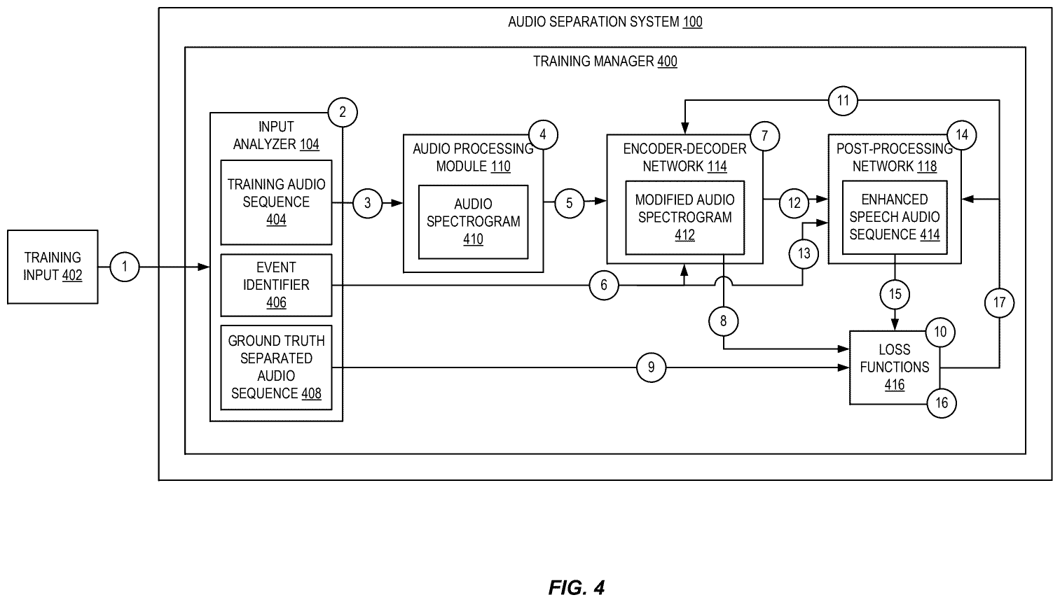

FIG. 4 illustrates a diagram of a process of training machine learning models to separate multiple classes of audio events from an audio sequence in accordance with one or more embodiments. In one or more embodiments, a training manager 400 is configured to train neural networks (e.g., encoder-decoder network 114 and post-processing network 118) to separate audio events from an audio sequence that includes speech and/or non-speech audio events. In some embodiments, the training manager 400 trains a single encoder-decoder network 114 and post-processing network 118 to separate multiple audio events.

In some embodiments, the training manager 400 is a part of an audio separation system 100. In other embodiments, the training manager 400 can be a standalone system, or part of another system, and deployed to the audio separation system 100. For example, the training manager 400 may be implemented as a separate system implemented on electronic devices separate from the electronic devices implementing audio separation system 100. As shown in FIG. 4, the training manager 400 receives a training input 402, as shown at numeral 1. For example, the audio separation system 100 receives the training input 402 from a user via a computing device or from a memory or storage location. The training input 402 further includes an event identifier 406 indicating a type of audio event (e.g., speech and non-speech) being requested for separation in the training audio sequence 404. In one embodiment, example non-speech audio event types include alarm, applause, birds, coughing, crying, engine, laughter, pets, traffic, and typing. Other types of non-speech audio event types can include reverberation, ambient noise, and music. Other embodiments can include fewer, additional, and/or different audio event types. The training input 402 further includes a ground truth separated audio sequence 408. The ground truth separated audio sequence 408 is an audio sequence of the audio event in the training audio sequence 404 indicated by the event identifier 406.

In some embodiments, the training audio sequence 404, the event identifier 406, and the ground truth separated audio sequence 408 can be received in a single training input 402 or in multiple inputs. In one or more embodiments, the training input 402 can be provided in a graphical user interface (GUI). For example, the training audio sequence 404 can be provided to the audio separation system 100, or a user can indicate a storage location (e.g., on a computing device) or a URL to a location storing the training audio sequence 404. The training input 402 can be part of a batch that includes multiple training audio sequences 404 and corresponding event identifiers 406 and ground truth separated audio sequence 408 that can be fed to the training manager 400 in parallel or in series.

In one or more embodiments, the audio separation system 100 includes an input analyzer 104 that receives the training input 402. In some embodiments, the input analyzer 104 is configured to extract the training audio sequence 404, the event identifier 406, and the ground truth separated audio sequence 408 from the training input 402, at numeral 2. The input analyzer 104 then sends the training audio sequence 404 to an audio processing module 110, as shown at numeral 3. In one or more embodiments, the audio processing module 110 generates an audio spectrogram 410 representing the training audio sequence 404, at numeral 4. The audio spectrogram 410 is a representation of the spectrum of frequencies in an audio signal over time. In one or more embodiments, the audio processing module 110 computes the audio spectrogram 410 representing the training audio sequence 404 using a short-time Fourier transform (STFT). The audio spectrogram 410 is then sent to an encoder-decoder network 114, as shown at numeral 5. In one or more embodiments, the event identifier 406 is also sent to the encoder-decoder network 114, as shown at numeral 6.

In one or more embodiments, the encoder-decoder network 114 processes the audio spectrogram 410 and the event identifier 406 to generate a modified audio spectrogram 412, at numeral 7. In one or more embodiments, the encoder-decoder network 114 is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the modified audio spectrogram 412 generated by the encoder-decoder network 114 is a representation of the training audio sequence 404 with the audio event specified by the event identifier 406 separated from the other speech and/or non-speech audio events in the training audio sequence 404.

After the encoder-decoder network 114 generates the modified audio spectrogram 412, the modified audio spectrogram 412 is converted to a modified audio sequence (e.g., an audio waveform) using inverse STFT and the modified audio sequence is sent to loss functions 416, as shown at numeral 8. The ground truth separated audio sequence 408 from the training input 402 is then passed to the loss functions 416, as shown at numeral 9. Using the modified audio sequence generated from the modified audio spectrogram 412 and the ground truth separated audio sequence 408, the loss functions 416 can calculate a loss, at numeral 10. In one or more embodiments, the loss functions 416 include a multi-resolution STFT magnitude loss, L_{mstft}, a mel-spectrogram loss, Lₘₑₗ, and a time-domain L2 loss, Lₜᵢₘₑ, which can be expressed as follows:

$${L}_{mstft} = {\sum }_{i} {‖ log \vert STFT ( y ; {θ}_{i} ) \vert - log \vert STFT ( {y}^{′} ; {θ}_{i} ) \vert ‖}_{1}$$

$${L}_{mel} = {\sum }_{i} {‖ log Mel ( y ) - log Mel {y}^{′} ‖}_{1}$$

$${L}_{time} = {\sum }_{i} {‖ y - {y}^{′} ‖}_{1}$$

In one or more embodiments, to further enhance the perceptual quality of the separation, the loss functions 416 integrate adversarial training with three types of audio discriminators: a multi-resolution STFT discriminator with five NFFT sizes (e.g., 256, 512, 1024, 2048, 4096), a multi-scale discriminator with four resolutions (e.g., 1, 2, 4, 8), and a multi-period discriminator with five periods (e.g., 2, 3, 5, 7, 11). In embodiments, the hinge version of the adversarial loss is used. Additionally, a feature matching loss, L_{FM}, can be adopted to enforce the generator to predict sources that match the target sources in the feature space of the discriminators. These losses can be expressed as follows:

$${L}_{adv} = - D ( {y}^{′} ) ; {L}_{D} = {[ 1 - D ( y ) ]}^{+} + {[ 1 + D ( {y}^{′} ) ]}^{+}$$

$${L}_{FM} = {\sum }_{i = 1}^{M} [ \frac{1}{{N}_{i}} {‖ {D}^{i} ( y ) - {D}^{i} ( {y}^{′} ) ‖}_{1} ]$$

where M is the number of layers in the discriminator, D, excluding the output layer, and Nᵢ is the number of units in the i-th layer of D. In summary, the total loss on the generator can then be expressed as:

$${L}_{G} = {L}_{time} + {λ}_{mstft} {L}_{mstft} + {λ}_{mel} {L}_{mel} + {λ}_{adv} {L}_{adv} + {λ}_{FM} {L}_{FM}$$

where λ's denote the scales for fusing different loss functions. In one or more embodiments, λ_{mstft}=0.01, λₘₑₗ=0.01, λ_{adv}=1, and λ_{FM}=10 for training single-class and multi-class models.

The calculated loss can then be backpropagated to train the encoder-decoder network 114, as shown at numeral 11.

In some embodiments, the audio separation system 100 includes a post-processing network 118. In such embodiments, the modified audio spectrogram 412 is sent to the post-processing network 118, as shown at numeral 12. In one or more embodiments, the event identifier 406 is also sent to the post-processing network 118, as shown at numeral 13. The post-processing network 118 generates an enhanced spectrogram, at numeral 14. In one or more embodiments, the post-processing network 118 is a neural network trained to generate an enhanced audio sequence 414 from the modified audio spectrogram 412, as described above with respect to FIGS. 1 and 2.

In one or more embodiments, the enhanced spectrogram is used to generate an enhanced audio sequence 414. In some embodiments, the enhanced audio sequence 414 is generated by processing the enhanced audio spectrogram generated by the post-processing network 118 through an inverse STFT. After the post-processing network 118 generates the enhanced audio sequence 414, the enhanced audio sequence 414 is sent to loss functions 416, as shown at numeral 15. Using the enhanced audio sequence 414 generated by the post-processing network 118 and the ground truth separated audio sequence 408 (e.g., previously received in numeral 9), the loss functions 416 can calculate a loss, at numeral 16. The loss is computed in the same manner and using the same loss functions as described above with respect to numeral 10. The calculated loss can then be backpropagated to train the post-processing network 118, as shown at numeral 17. In one or more embodiments, the calculated loss can also be backpropagated to train the encoder-decoder network 114. In one or more embodiments, when the post-processing network 118 is used, the loss calculated using the output of the encoder-decoder network 114 at numeral 10 can be skipped in favor of the loss calculated using the output of the post-processing network 118 at numeral 16.

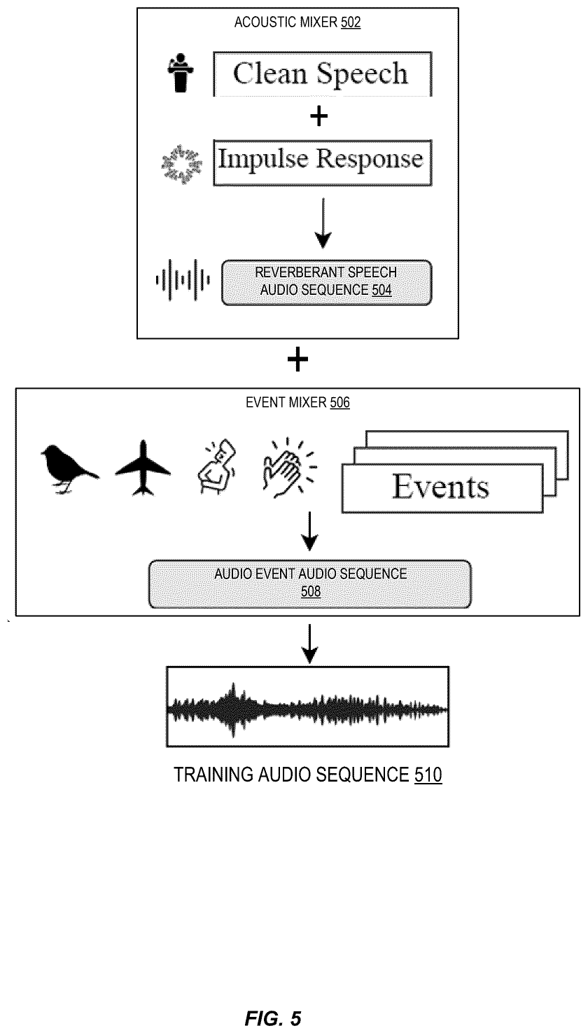

FIG. 5 illustrates a diagram of a process of generating a simulated dataset of training audio sequences in accordance with one or more embodiments. In one or more embodiments, a training audio sequence is generated using audio from multiple audio datasets. In such embodiments, a clean speech audio clip (e.g., audio recorded in an acoustic environment) and impulse response information (e.g., reverberation) are randomly sampled from the audio datasets. In one or more embodiments, the impulse response information can be a digital filter that describes the sound received at a capture device when a brief impulsive sound is emitted in an acoustic environment. An acoustic mixer 502 then combines the clean speech audio clip and the impulse response information to create a reverberant speech audio sequence 504. In one or more embodiments, the acoustic mixer 502 further can augment the clips used to create the reverberant speech audio sequence 504. For example, the acoustic mixer 502 can change the equalizations of the clips (e.g., manipulate the frequency response in some Hz). Augmentations to speech audio clips can include randomly shrinking or stretching the signal and/or randomly scaling the volume. Augmentations to the impulse response can include randomly shrinking or stretching the late reverberation part, randomly scaling up or scaling down the early reflection. In one or embodiments, a random multi-band filter can be combined (e.g., convolved) with the impulse response filter of reverb to simulate equalization for speech.

Next, an event mixer 506 randomly samples an audio event audio sequence 508 from a target audio event type. The target audio event type can be speech, a non-speech audio event and/or ambient noise. In one embodiment, example non-speech audio event types include alarm, applause, birds, coughing, crying, engine, laughter, pets, traffic, and typing. In one or more embodiments, event mixer 506 randomly selects a target audio event type (e.g., speech or non-speech). If the target audio event type is a non-speech type, the event mixer 506 then samples an audio event audio sequence 508 for the target audio event type; otherwise the event mixer 506 uses the reverberant speech audio sequence 504. In addition, a side audio event clip is randomly sampled to provide interference for half of the time. In one or more embodiments, the side audio event clip can also be augmented as described above. In one or more embodiments, the event mixer 506 can augment the audio event audio sequence 508 by applying random seven-band equalization (EQ). The event mixer 506 then mixes the audio event audio sequence 508 with the reverberant speech audio sequence 504 and the side audio event clip to generate training audio sequence 510. As noted above, for speech audio event types, audio event audio sequence 508 is the same as reverberant speech audio sequence 504, and the event mixer 506 mixes the audio event audio sequence 508 with the side audio event clip to generate training audio sequence 510. In some embodiments, the event mixer 506 uses a range of SNR customized for each audio event type. The audio event audio sequence 508 serves as the ground truth (e.g., ground truth separated audio sequence 408 in FIG. 4). After this process, the training audio sequence 510 includes the target audio event, and also reverberant speech, background noises and multiple side audio events. In one or more embodiments, the training audio sequence 510 is part of a batch of training audio sequences 510, each with a corresponding ground truth separated audio sequence. In some embodiments, the batch of training audio sequences 510 can include a random sampling of speech and non-speech audio event types. In other embodiments, the batch of training audio sequences 510 can includes data for a single audio event type. In such embodiments, the audio separation system 100 can be trained to separate the single audio event type. In embodiments, training with this augmented training data can enhance the separation capability of the neural network models, without resulting in degradation in no-speech scenarios.

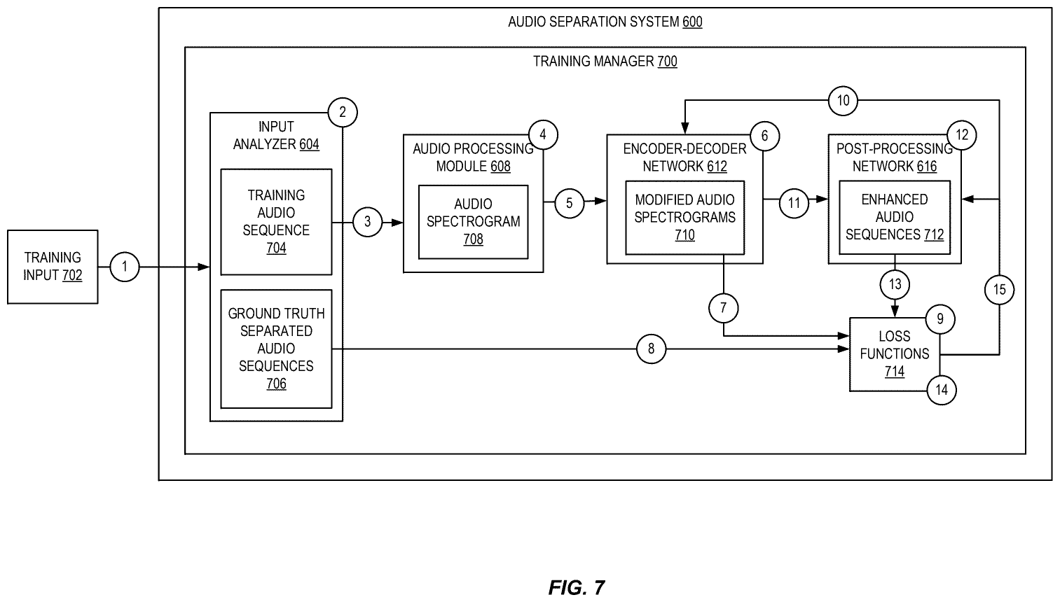

In one or more embodiments, the process of generating a simulated dataset of training audio sequences for a multi-event separation is performed in a similar manner. However, the training audio sequence 510 will be generated to include audio from a plurality of target audio event types (e.g., all the audio event types the audio separation system is to be trained to separate). In one or more embodiments, the output audio event types to be separated are defined prior to training. In such embodiments, the event mixer 506 randomly samples one or more audio event audio sequences 508, one for each of the output audio event types to be separated. The event mixer 506 then augments each of the audio event audio sequences 508 as described above. The event mixer 506 then mixes the one or more audio event audio sequences 508 to create training audio sequence 510. The one or more audio event audio sequences 508 are then treated as the ground truth separated audio sequences (e.g., ground truth separated audio sequences 706 in FIG. 7) for loss calculation during training. In other embodiments, the event mixer 506 can select no audio event audio sequences 508, in which case the ground truth separated audio sequence is a silent audio track for the corresponding audio event type.

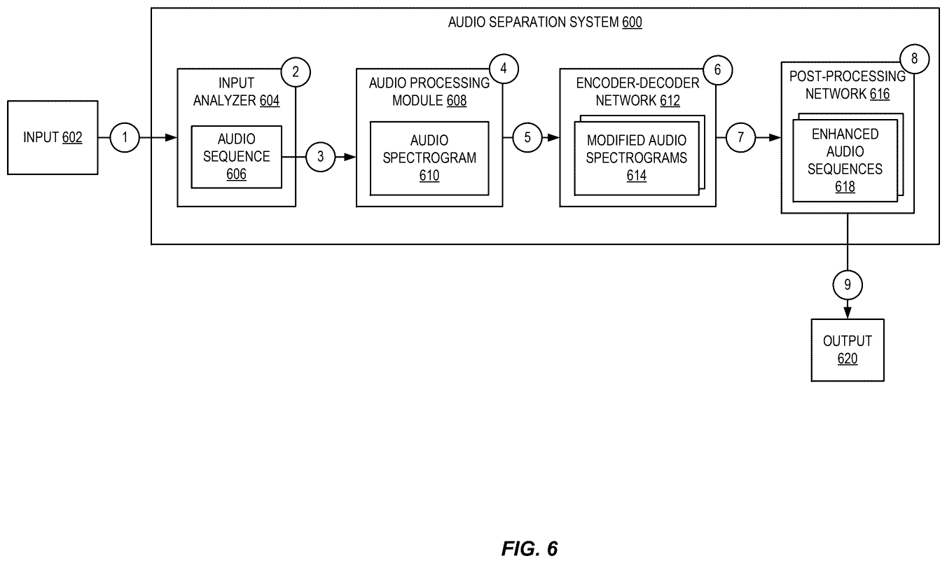

FIG. 6 illustrates a diagram of a process of a multi-event separation of audio events from an audio sequence in accordance with one or more embodiments. In multi-event separation, the audio separation system 600 can simultaneously separate multiple audio tracks based on a defined list of output categories. As shown in FIG. 6, an audio separation system 600 receives an input 602, as shown at numeral 1. For example, the audio separation system 600 receives the input 602 from a user via a computing device or from a memory or storage location, where the input 602 includes at least an audio sequence (e.g., audio sequence 606). The audio sequence 606 can be an audio waveform that is a mixture of various events (e.g., speech, non-speech audio events, background noise, etc.). In one or more embodiments, the audio separation system 600 is trained to separate audio events from the audio sequence 606 into a plurality of separated audio sequences or separated audio tracks, where each of the plurality of separated audio sequences or separated audio tracks is defined for a specific audio event type. The audio events that the audio separation system 600 is trained to separate can include speech and non-speech audio events. For example, separated audio sequence 1 can be where speech audio events are separated, separated audio sequence 1 can be where applause audio events are separated, etc. For example, if the audio separation system 600 is trained to separate ten types of audio events, an output of passing the audio sequence 606 through the audio separation system 600 can be separated audio sequences 1-10, one for each of the ten types of audio events.

If the audio sequence 606 does not have audio events of a certain defined audio event type that the audio separation system 600 is trained to separate, the corresponding separated audio sequence for that audio event type will be empty or NULL. For example, if the audio sequence 606 does not include audio events that would be stored as separated audio sequence 5, an output of passing the audio sequence 606 through the audio separation system 600 would be separated audio sequences stored in separated audio sequences 1-4 and 6-10, with separated audio sequence 5 being empty (e.g., a silent track).

In one or more embodiments, the input 602 can be provided in a graphical user interface (GUI). For example, the audio sequence 606 can be provided to the audio separation system 600, or a user can indicate a storage location (e.g., on a computing device) or a URL to a location storing the audio sequence 606.

In one or more embodiments, the audio separation system 600 includes an input analyzer 604 that receives the input 602. In some embodiments, the input analyzer 604 is configured to extract the audio sequence 606 from the input 602, at numeral 2. The input analyzer 604 then sends the audio sequence 606 to an audio processing module 608, as shown at numeral 3. In one or more embodiments, the audio processing module 608 generates an audio spectrogram 610 representing the audio sequence 606, at numeral 4. The audio spectrogram 610 is a representation of the spectrum of frequencies in an audio signal over time. In one or more embodiments, the audio processing module 608 computes the audio spectrogram 610 representing the audio sequence 606 using a short-time Fourier transform (STFT). The audio spectrogram 610 is then sent to an encoder-decoder network 612, as shown at numeral 5.

In one or more embodiments, the encoder-decoder network 612 processes the audio spectrogram 610 to generate modified audio spectrogram 614, at numeral 6. In one or more embodiments, the encoder-decoder network 612 is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the encoder-decoder network 612 takes in the real-imaginary spectrogram (e.g., audio spectrogram 610),

$$X = ( {X}_{real} , {X}_{imag} ) ∈$$

computed from an input mixture waveform x (e.g., audio sequence 606).

In one or more embodiments, the modified audio spectrograms 614 generated by the encoder-decoder network 612 are representations of the audio sequence 606 with audio events of audio event types that the encoder-decoder network 612 has been trained to separate. For example, if the encoder-decoder network 612 has been trained to separate ten audio event types from audio sequences, the encoder-decoder network 612 generates ten modified audio spectrograms 614. In one or more embodiments, one or more modified audio spectrograms 614 can be empty of NULL if the audio sequence 606 does not include one or more audio event types. In one or more embodiments, an output 2N-channel matrix,

$${Y}^{′} = ( {{Y}^{′}}_{real}^{1} , {{Y}^{′}}_{imag}^{1} , {{Y}^{′}}_{real}^{2} , {{Y}^{′}}_{imag}^{2} , ... , {{Y}^{′}}_{real}^{N} , {{Y}^{′}}_{imag}^{N} )$$

represents a stack of real and imaginary components of the N modified audio spectrograms 614, from which the separated waveforms,

$${{y}^{′}}_{( b )}^{1} , {{y}^{′}}_{( b )}^{2} , ... , {{y}^{′}}_{( b )}^{N} ,$$

are obtained, where N is the number of audio event types the audio separation system 600 has been trained to separate. In one or more embodiments, multiplicative skip connections are used between the encoder and the decoder, which can enhance the network's separation capability by masking on audio features of different resolutions. In one or more embodiments, the modified audio spectrograms 614 can be converted to N audio tracks and provided as a preliminary output.

In some embodiments, the audio separation system 600 includes a post-processing network 616 to enhance the separated audio sequences. In such embodiments, the modified audio spectrograms 614 are sent to the post-processing network 616, as shown at numeral 7. The post-processing network 616 generates the enhanced audio sequences 618, at numeral 8. In one or more embodiments, the post-processing network 616 receives the 2N-channel matrix produced by the encoder-decoder network 612 and outputs a refined 2N-channel matrix. In one or more embodiments, the post-processing network 616 is a neural network trained to generate an enhanced audio spectrogram from the modified audio spectrograms 614. As illustrated in FIG. 2, an exemplary post-processing network 616 includes a two-dimensional CNN layer and two TFC-TDF modules.

After the post-processing network 616 generates the enhanced audio spectrogram, the enhanced audio spectrogram can be used to generate the enhanced audio sequences 618. In some embodiments, the enhanced audio sequences 618 are generated by processing enhanced audio spectrogram generated by the post-processing network 616 through an inverse STFT.

The enhanced audio sequences 618 can be sent as an output 620, as shown at numeral 9. In one or more embodiments, after the process described above in numerals 1-8, the output 620 is sent through a communications channel to the user device or computing device that provided the input, to another computing device associated with the user or another user, or to another system or application.

In one or more embodiments, the audio separation system 600 can split the audio sequence 606 into a plurality of defined categories, where the categorization of the tracks can be based on the training data used to train the audio separation system 600. For example, the audio separation system 600 can split the audio sequence 606 into a speech track, a music track, and an ambient noise track, where the ambient noise track can include stationary noise and audio events other than speech and music (e.g., non-speech sound events). In another example, the music and ambient noise tracks can be combined into a single non-speech track, resulting in an output of two tracks: a speech track and a non-speech track. Another example category of audio events that the audio separation system 100 can be trained to output as a track includes natural sounds (e.g., animal sounds, wind, etc.).

In one or more embodiments, the audio separation system 600 can also generate an additional audio sequence (e.g., a remainder audio sequence or audio track) that includes the remainder of the audio sequence 606 after the various separated audio events have been separated and/or extracted from the audio sequence 606. In some embodiments, the remainder audio sequence can be generated by subtracting the enhanced audio sequences 618 produced by the audio separation system 600 from the audio sequence 606. The remainder audio sequence can be presented as an output with the enhanced audio sequences 618 for each of the target audio event types.

In one or more embodiments, the remainder audio sequence can be a reverberation tail audio sequence or late reverberation of the reverberant speech audio sequence, which is the residual reverberated sound that occurs after the direct arrival and early reflections of the source sound. In one or more embodiments, the reverberation tail audio sequence is the result of separating out or extracting the speech, non-speech sound events, background noise, and background music. In such embodiments, the audio separation system 600 can include a graphical user interface with interface elements (e.g., buttons, dials, etc.) to allow a user to adjust an amount of reverberant speech to include in a final output audio mixture. In other embodiments, the remainder audio sequence can include additional or different audio (e.g., non-speech audio events the audio separation system 600 has not been trained to separate). For example, the remainder audio sequence can be an ambient noise audio generated by subtracting the speech audio and the background music audio from the audio sequence, or the remainder audio sequence can be a mixture of the audio events in audio sequence that were excluded from the plurality of audio event types the audio separation system 600 is trained to separate.

In one or more embodiments, the audio separation system 600 can perform the separation of audio events to each of the channels of an input audio sequence independently, while maintaining the inter-channel relationships of the channels of the input audio sequence. The audio separation system 100 can preserve the original time signal information in the separation results, such as the phase, timing, amplitude and acoustic properties (e.g., reverb and EQ) of the audio events to be same as in the input audio sequence. For multi-channel audio sequences, this means the inter-channel relationship (e.g., the correlation of occurrence of the same audio event, and the channel differences in phase, arrival time, amplitude and acoustics) are maintained even when the separation is applied to each channel independently. This also allows the perceived locality of the separated sound sources to be consistent with how they sound like in the input audio sequence. In such embodiments, maintaining the inter-channel relationship of the channels of the input audio sequence allows the audio event separation to be used on separate sounds from stereo audio, 5.1-channel surround sound, and all other multi-channel formats. In such embodiments, the resulting separated audio sequences will retain the same auditory locality of all non-speech sounds and speech as the multi-channel input audio sequence.

FIG. 7 illustrates a diagram of a process of training machine learning models to perform a multi-event separation of multiple classes of audio events from an audio sequence in accordance with one or more embodiments. In one or more embodiments, a training manager 700 is configured to train neural networks (e.g., encoder-decoder network 612 and post-processing network 616) to separate audio events from an audio sequence that may include speech and/or non-speech audio events. In some embodiments, the training manager 700 trains a single encoder-decoder network 612 and post-processing network 616 to separate multiple audio events simultaneously.

In some embodiments, the training manager 700 is a part of an audio separation system 600. In other embodiments, the training manager 700 can be a standalone system, or part of another system, and deployed to the audio separation system 600. For example, the training manager 700 may be implemented as a separate system implemented on electronic devices separate from the electronic devices implementing audio separation system 600. As shown in FIG. 7, the training manager 700 receives a training input 702, as shown at numeral 1. For example, the audio separation system 600 receives the training input 702 from a user via a computing device or from a memory or storage location. The training input 702 further includes one or more ground truth separated audio sequences 706. Each of the one or more ground truth separated audio sequences 706 is an audio sequence of one of the audio events in the training audio sequence 704 the audio separation system 600 is being trained to separate.

In some embodiments, the training audio sequence 704 and the ground truth separated audio sequence 706 can be received in a single training input 702 or in multiple inputs. In one or more embodiments, the training input 702 can be provided in a graphical user interface (GUI). For example, the training audio sequence 704 can be provided to the audio separation system 600, or a user can indicate a storage location (e.g., on a computing device) or a URL to a location storing the training audio sequence 704. The training input 702 can be part of a batch that includes multiple training audio sequences 704 and ground truth separated audio sequences 706 that can be fed to the training manager 700 in parallel or in series.

In one or more embodiments, the audio separation system 600 includes an input analyzer 604 that receives the training input 702. In some embodiments, the input analyzer 604 is configured to extract the training audio sequence 704 and the ground truth separated audio sequences 706 from the training input 702, at numeral 2. The input analyzer 604 then sends the training audio sequence 704 to an audio processing module 608, as shown at numeral 3. In one or more embodiments, the audio processing module 608 generates an audio spectrogram 708 representing the training audio sequence 704, at numeral 4. The audio spectrogram 708 is a representation of the spectrum of frequencies in an audio signal over time. In one or more embodiments, the audio processing module 608 computes the audio spectrogram 708 representing the training audio sequence 704 using a short-time Fourier transform (STFT). The audio spectrogram 708 is then sent to an encoder-decoder network 612, as shown at numeral 5.

In one or more embodiments, the encoder-decoder network 612 processes the audio spectrogram 708 to generate modified audio spectrograms 710, at numeral 6. In one or more embodiments, the encoder-decoder network 612 is a neural network. In one or more embodiments, the modified audio spectrograms 710 generated by the encoder-decoder network 612 are each representations of a different audio event type separated from the training audio sequence 704.

After the encoder-decoder network 612 generates the modified audio spectrograms 710, the modified audio spectrograms 710 are converted to modified audio sequences (e.g., audio waveforms) using inverse STFT and the modified audio sequences are sent to loss functions 714, as shown at numeral 7. The ground truth separated audio sequences 706 from the training input 702 are then passed to the loss functions 714, as shown at numeral 8. Using the modified audio sequences generated from the modified audio spectrograms 710 and the ground truth separated audio sequences 706, the loss functions 714 can calculate a loss, at numeral 9. In one or more embodiments, the loss functions 714 include a multi-resolution STFT magnitude loss, L_{mstft}, a mel-spectrogram loss, Lₘₑₗ, and a time-domain L2 loss, Lₜᵢₘₑ, which can be expressed as follows:

$${L}_{mstft} = {\sum }_{i} {‖ log \vert STFT ( y ; {θ}_{i} ) \vert - log \vert STFT ( {y}^{′} ; {θ}_{i} ) \vert ‖}_{1}$$

$${L}_{mel} = {\sum }_{i} {‖ log Mel ( y ) - log Mel {y}^{′} ‖}_{1}$$

$${L}_{time} = {\sum }_{i} {‖ y - {y}^{′} ‖}_{1}$$

In one or more embodiments, to further enhance the perceptual quality of the separation, the loss functions 714 integrate adversarial training with three types of audio discriminators: a multi-resolution STFT discriminator with five NFFT sizes (e.g., 256, 512, 1024, 2048, 7096), a multi-scale discriminator with four resolutions (e.g., 1, 2, 4, 8), and a multi-period discriminator with five periods (e.g., 2, 3, 5, 7, 11). In embodiments, the hinge version of the adversarial loss is used. Additionally, a feature matching loss, L_{FM}, can be adopted to enforce the generator to predict sources that match the target sources in the feature space of the discriminators. These losses can be expressed as follows:

$${L}_{adv} = - D ( {y}^{′} ) ; {L}_{D} = {[ 1 - D ( y ) ]}^{+} + {[ 1 + D ( {y}^{′} ) ]}^{+}$$

$${L}_{FM} = {\sum }_{i = 1}^{M} [ \frac{1}{{N}_{i}} {‖ {D}^{i} ( y ) - {D}^{i} ( {y}^{′} ) ‖}_{1} ]$$

where M is the number of layers in the discriminator, D, excluding the output layer, and Nᵢ is the number of units in the i-th layer of D. In summary, the total loss on the generator can then be expressed as:

$${L}_{G} = {L}_{time} + {λ}_{mstft} {L}_{mstft} + {λ}_{mel} {L}_{mel} + {λ}_{adv} {L}_{adv} + {λ}_{FM} {L}_{FM}$$

where λ's denote the scales for fusing different loss functions. In one or more embodiments, λ_{mstft}=0.01, λₘₑₗ=0.01, λ_{adv}=1, and λ_{FM}=10 for training single-class and multi-class models.

In one or more embodiments, the loss functions 714 can be the same or different for each of the output audio event types. In some embodiments, the GAN training can use either a set of discriminators that take in the stacked N modified audio sequence generated from the modified audio spectrograms 710, or one independent set of discriminators for each output audio event type that takes in the corresponding modified audio sequence. In one or more embodiments, the loss functions 714 are calculated for each audio event type and then summed together. The calculated loss can then be backpropagated to train the encoder-decoder network 612, as shown at numeral 10.

In some embodiments, the audio separation system 600 includes a post-processing network 616. In such embodiments, the modified audio spectrograms 710 are sent to the post-processing network 616, as shown at numeral 11. The post-processing network 616 generates enhanced audio sequences, at numeral 12. In one or more embodiments, the post-processing network 616 is a neural network trained to generate enhanced audio sequences 712 from the modified audio spectrograms 710, as described above with respect to FIGS. 1 and 2.

In one or more embodiments, the post-processing network 616 uses the modified audio spectrograms 710 to generate the enhanced audio sequences 712. In some embodiments, the enhanced audio sequences 712 are generated by processing enhanced audio spectrograms generated by the post-processing network 616 through an inverse STFT. After the post-processing network 616 generates the enhanced audio sequences 712, the enhanced audio sequences 712 are sent to loss functions 714, as shown at numeral 13. Using the enhanced audio sequences 712 generated by the post-processing network 616 and the ground truth separated audio sequences 706 (e.g., previously received in numeral 8), the loss functions 714 can calculate a loss, at numeral 14. The loss is computed in the same manner and using the same loss functions as described above with respect to numeral 9. The calculated loss can then be backpropagated to train the post-processing network 616, as shown at numeral 15. In one or more embodiments, the calculated loss can also be backpropagated to train the encoder-decoder network 612. In one or more embodiments, when the post-processing network 616 is used, the loss calculated using the output of the encoder-decoder network 612 at numeral 9 can be skipped in favor of the loss calculated using the output of the post-processing network 616 at numeral 14.

In some embodiments, the training manager 700 trains a single encoder-decoder network 612 and post-processing network 616 to separate a single audio event type. In such embodiments, if there are ten audio event types, the training manager 700 trains ten sets of models (e.g., ten encoder-decoder networks 612 and ten post-processing networks 616).

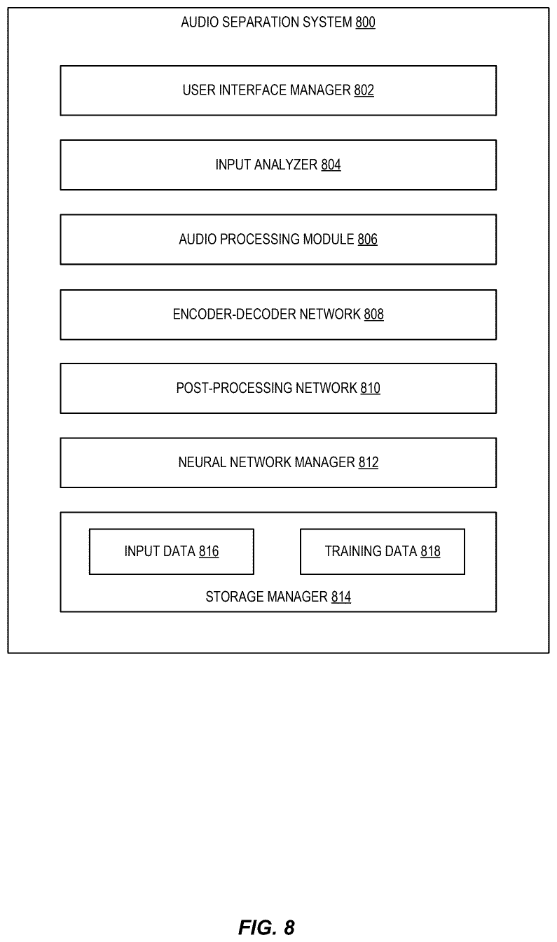

FIG. 8 illustrates a schematic diagram of an audio separation system (e.g., “audio separation system” described above) in accordance with one or more embodiments. As shown, the audio separation system 800 may include, but is not limited to, a user interface manager 802, an input analyzer 804, an audio processing module 806, an encoder-decoder network 808, a post-processing network 810, a neural network manager 812, and a storage manager 814. The storage manager 814 includes input data 816 and training data 818.

As illustrated in FIG. 8, the audio separation system 800 includes a user interface manager 802. For example, the user interface manager 802 allows users to provide input data to the audio separation system 800. In some embodiments, the user interface manager 802 provides a user interface through which the user can upload a document or file (e.g., an audio sequence), as discussed above. Alternatively, or additionally, the user interface may enable the user to download the document or file from a local or remote storage location (e.g., by providing an address, such as a URL or other endpoint, associated with a data source).

As further illustrated in FIG. 8, the audio separation system 800 also includes an input analyzer 804 that receives an input (e.g., from the user interface manager 802). The input analyzer 804 analyzes the input received to identify at least an audio sequence from the input. In embodiments where the audio separation system 800 performs audio separation based on an indicated audio event type, the input analyzer 804 analyzes the input to identify an event identifier from the input. During a training process, the input analyzer 804 analyzes a training input received to identify at least a training audio sequence, one or more ground truth separated audio sequences, and optionally an event identifier.

As further illustrated in FIG. 8, the audio separation system 800 also includes an audio processing module 806 configured to transform audio sequences (e.g., audio waveforms) into audio spectrograms. In one or more embodiments, the audio processing module 806 uses short-time Fourier transform (STFT) to generate the audio spectrograms. In one or more embodiments, the audio processing module 806 is also configured to generate audio waveforms from audio spectrograms using an inverse STFT.

As further illustrated in FIG. 8, the audio separation system 800 also includes an encoder-decoder network 808 trained to process an audio spectrogram and an event identifier indicating a type of audio event (e.g., speech or non-speech) to generate a modified audio spectrogram. In embodiment where the audio separation system 800 performs multi-event audio separation, the encoder-decoder network 808 is trained to process an audio spectrogram to generate one or more modified audio spectrograms. The one or more audio spectrograms are generated based on the types of audio events that the encoder-decoder network 808 is trained to predict and separate. In one or more embodiments, the encoder-decoder network 808 is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In one embodiment, the encoder of the encoder-decoder network 808 includes a two-dimensional convolutional neural network (2D-CNN) layer followed by five groups of Time-Frequency Convolution and Time Distributed Fully-Connected Network (TFC-TDF) modules with 2D-CNN layers in between. In one or more embodiments, the bottleneck of the encoder-decoder network 808 includes a single TFC-TDF module. In one or more embodiments, the decoder of the encoder-decoder network 808 replicates the encoder structure with 2D deconvolution neural network (2D-DCNN) layer for upsampling in between.

As further illustrated in FIG. 8, the audio separation system 800 also includes a post-processing network 810. In one or more embodiments, the post-processing network 810 receives the one or more modified audio spectrograms from the encoder-decoder network 808 and, optionally, an event identifier indicating a type of audio event. In one or more embodiments, the post-processing network 810 is a neural network trained to generate an one or more enhanced audio sequences from the one or more modified audio spectrograms. In one or more embodiments, the post-processing network 810 includes a two-dimensional CNN layer and two TFC-TDF modules.

As illustrated in FIG. 8, the audio separation system 800 also includes a neural network manager 812. Neural network manager 812 may host a plurality of neural networks or other machine learning models used by the modules of the audio separation system 800. The neural network manager 812 may include an execution environment, libraries, and/or any other data needed to execute the machine learning models. In some embodiments, the neural network manager 812 may be associated with dedicated software and/or hardware resources to execute the machine learning models. Although depicted in FIG. 8 as being hosted by a single neural network manager 812, in various embodiments the neural networks may be hosted in multiple neural network managers and/or as part of different components.

As illustrated in FIG. 8, the audio separation system 800 also includes the storage manager 814. The storage manager 814 maintains data for the audio separation system 800. The storage manager 814 can maintain data of any type, size, or kind as necessary to perform the functions of the audio separation system 800. The storage manager 814, as shown in FIG. 8, includes input data 816 and training data 818. In particular, the input data 816 may include an audio sequence and an event identifier received by the audio separation system 800. The training data 818 may include a training audio sequence and one or more ground truth separated audio sequences. The one or more ground truth separated audio sequences include audio from the training audio sequence of an audio event type (e.g., speech or non-speech). In some embodiments, the training data 818 may include event identifiers used to indicate a particular audio event type. The training data 818 may be used by the audio separation system 800 to train the encoder-decoder network 808 and the post-processing network 810.

Each of the components 802-814 of the audio separation system 800 and their corresponding elements (as shown in FIG. 8) may be in communication with one another using any suitable communication technologies. It will be recognized that although components 802-814 and their corresponding elements are shown to be separate in FIG. 8, any of components 802-814 and their corresponding elements may be combined into fewer components, such as into a single facility or module, divided into more components, or configured into different components as may serve a particular embodiment.

The components 802-814 and their corresponding elements can comprise software, hardware, or both. For example, the components 802-814 and their corresponding elements can comprise one or more instructions stored on a computer-readable storage medium and executable by processors of one or more computing devices. When executed by the one or more processors, the computer-executable instructions of the audio separation system 800 can cause a client device and/or a server device to perform the methods described herein. Alternatively, the components 802-814 and their corresponding elements can comprise hardware, such as a special purpose processing device to perform a certain function or group of functions. Additionally, the components 802-814 and their corresponding elements can comprise a combination of computer-executable instructions and hardware.

Furthermore, the components 802-814 of the audio separation system 800 may, for example, be implemented as one or more stand-alone applications, as one or more modules of an application, as one or more plug-ins, as one or more library functions or functions that may be called by other applications, and/or as a cloud-computing model. Thus, the components 802-814 of the audio separation system 800 may be implemented as a stand-alone application, such as a desktop or mobile application. Furthermore, the components 802-814 of the audio separation system 800 may be implemented as one or more web-based applications hosted on a remote server. Alternatively, or additionally, the components of the audio separation system 800 may be implemented in a suite of mobile device applications or “apps.”

As shown, the audio separation system 800 can be implemented as a single system. In other embodiments, the audio separation system 800 can be implemented in whole, or in part, across multiple systems. For example, one or more functions of the audio separation system 800 can be performed by one or more servers, and one or more functions of the audio separation system 800 can be performed by one or more client devices. The one or more servers and/or one or more client devices may generate, store, receive, and transmit any type of data used by the audio separation system 800, as described herein.

In one implementation, the one or more client devices can include or implement at least a portion of the audio separation system 800. In other implementations, the one or more servers can include or implement at least a portion of the audio separation system 800. For instance, the audio separation system 800 can include an application running on the one or more servers or a portion of the audio separation system 800 can be downloaded from the one or more servers. Additionally, or alternatively, the audio separation system 800 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including audio sequences stored at the one or more servers. The one or more servers can then automatically perform the methods and processes described above to perform a multi-class separation of audio events from the audio sequence.

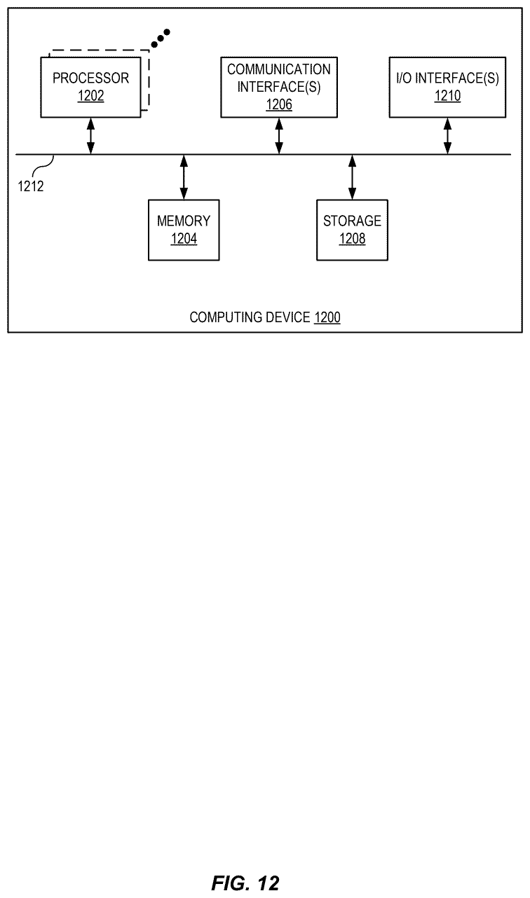

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 12. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 12.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 12.

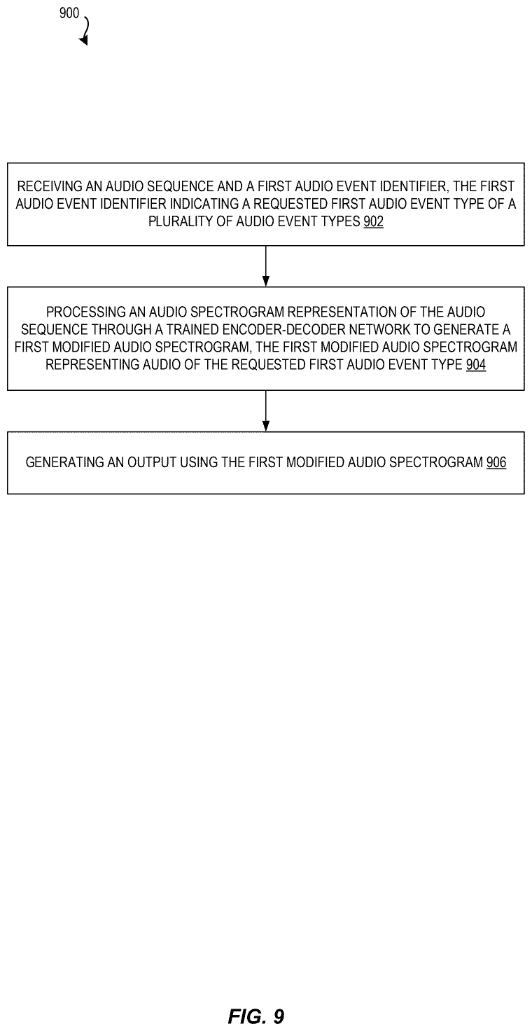

FIGS. 1-8, the corresponding text, and the examples, provide a number of different systems and devices that separate audio events from an audio sequence in accordance with one or more embodiments. In addition to the foregoing, embodiments can also be described in terms of flowcharts comprising acts and steps in a method for accomplishing a particular result. For example, FIGS. 9-11 illustrate flowcharts of exemplary methods in accordance with one or more embodiments. The methods described in relation to FIGS. 9 and 8 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart of a series of acts in a method of separating audio events from an audio sequence in accordance with one or more embodiments. In one or more embodiments, the method 900 is performed in a digital medium environment that includes the audio separation system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of receiving an audio sequence and a first audio event identifier, the first audio event identifier indicating a requested first audio event type of a plurality of audio event types. In one or more embodiments, an audio separation system (e.g., audio separation system 800) receives an input that includes an audio sequence. The audio separation system can also receive the first audio event identifier that indicates a first type of audio event (e.g., speech or non-speech) to separate from the audio sequence. In one embodiment, example non-speech audio event types include alarm, applause, birds, coughing, crying, engine, laughter, pets, traffic, and typing. Other types of non-speech audio event types can include reverberation, ambient noise, and music. Other embodiments can include fewer, additional, and/or different audio event types.

In one or more embodiments, the audio sequence and the first audio event identifier are received in a single input. In other embodiments, the audio sequence and the first audio event identifier are received in multiple inputs. For example, the first audio event identifier can be received in a graphical user interface (GUI) after the audio sequence has been received by the audio separation system.

As illustrated in FIG. 9, the method 900 includes an act 904 of processing an audio spectrogram representation of the audio sequence through a trained encoder-decoder network to generate a first modified audio spectrogram, the first modified audio spectrogram representing the audio of the requested first audio event type. In one or more embodiments, the audio separation system generates the audio spectrogram from the audio sequence using a short-time Fourier transform (STFT). The trained encoder-decoder network then receives the audio spectrogram. In one or more embodiments, the encoder-decoder network is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In embodiments, the audio spectrogram and an embedding, or vector representation, of the first audio event identifier are processed through layers of the encoder-decoder network with the output being a first modified audio spectrogram. The first modified audio spectrogram is a representation of an audio sequence that includes only the audio event indicated by the first audio event identifier.

As illustrated in FIG. 9, the method 900 includes an act 906 of generating an output using the first modified audio spectrogram. In some embodiments, the first modified audio spectrogram can be converted to an audio waveform using an inverse STFT and provided as an output. In other embodiments, the first modified audio spectrogram can be sent to a post-processing network. The post-processing network can be a neural network trained to generate a first enhanced audio sequence using the first modified audio spectrogram and the first audio event identifier. In such embodiments, the first enhanced audio sequence can then be provided as an output.

In one or more embodiments, the audio separation system can receive a second audio event identifier indicating a requested second audio event type for separation in the audio sequence, where the first audio event type is different from the second audio event type. In one or more embodiments, the audio separation system can process the audio spectrogram representation of the audio sequence and the second event identifier through the trained encoder-decoder network to generate a second modified audio spectrogram, the second modified audio spectrogram representing the audio of the requested second audio event type separated out from the audio sequence. The second modified audio spectrogram can then be provided to the post-processing network to generate a second enhanced audio sequence.

In embodiments, the audio separation system can display information (e.g., in a GUI) that indicates a plurality of enhanced audio sequences, including the first enhanced audio sequence and the second enhanced audio sequence. For example, the GUI can provide a user with interface elements (e.g., buttons, icons, etc.) to select one or more of the plurality of enhanced audio sequence. In one or more embodiments, the GUI can also provide the user with interface elements to mix the one or more of the plurality of enhanced audio sequences at different ratios (e.g., volumes). Based on the selections, the audio separation system can generate a modified audio sequence that includes the selected one or more of the plurality of enhanced audio sequences and provide the modified audio sequence as the output.

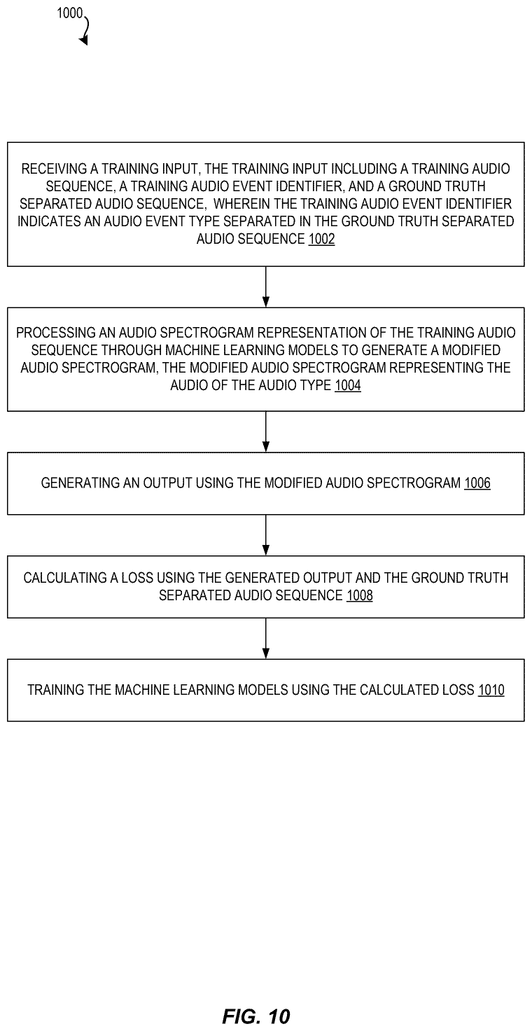

FIG. 10 illustrates a flowchart of a series of acts in a method of training machine learning models to separate audio events from an audio sequence in accordance with one or more embodiments. In one or more embodiments, the method 1000 is performed in a digital medium environment that includes the audio separation system 100. The method 1000 is intended to be illustrative of one or more methods in accordance with the present disclosure and is not intended to limit potential embodiments. Alternative embodiments can include additional, fewer, or different steps than those articulated in FIG. 10.

As illustrated in FIG. 10, the method 1000 includes an act 1002 of receiving a training input, the training input including a training audio sequence, a training audio event identifier, and a ground truth separated audio sequence, wherein the training audio event identifier indicates an audio event type (e.g., speech or non-speech) separated in the ground truth separated audio sequence. In one or more embodiments, an audio separation system (e.g., audio separation system 100) receives the training input in a single input or in multiple inputs. The training input can be part of a batch that includes multiple training audio sequences and corresponding event identifiers and ground truth separated audio sequences that can be fed to the training manager in parallel or in series.

In one or more embodiments, the training input can be generated through a data simulation process. In some embodiments, the training audio sequence is generated using audio from multiple audio datasets. In such embodiments, a clean speech audio clip (e.g., audio recorded in an acoustic environment), and impulse response information (e.g., reverberation) are randomly sampled from the audio datasets. An acoustic mixer then combines the clean speech audio clip and the impulse response information to create a reverberant speech audio sequence. Then, an event mixer randomly samples an audio event audio sequence from a target audio event type. The target audio event type can be speech, a non-speech audio event and/or ambient noise. In one embodiment, example non-speech audio event types include alarm, applause, birds, coughing, crying, engine, laughter, pets, traffic, and typing. In one or more embodiments, the event mixer randomly selects a target audio event type (e.g., speech or non-speech). If the target audio event type is a non-speech type, the event mixer then samples an audio event audio sequence for the target audio event type; otherwise the event mixer uses the reverberant speech audio sequence. The event mixer then mixes the audio event audio sequence with the reverberant speech audio sequence and the side audio event clip to generate a training audio sequence. The audio event audio sequence serves as the ground truth (e.g., a ground truth separated audio sequence). After this process, the training audio sequence includes the target audio event, and also reverberant speech, background noises and multiple side audio events.

As illustrated in FIG. 10, the method 1000 includes an act 1004 of processing an audio spectrogram representation of the training audio sequence through machine learning models to generate a modified audio spectrogram, the modified audio spectrogram representing the audio of the audio event type. In one or more embodiments, the audio separation system generates the audio spectrogram from the training audio sequence using a short-time Fourier transform (STFT). An encoder-decoder network then receives the audio spectrogram. In one or more embodiments, the encoder-decoder network is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In embodiments, the audio spectrogram and an embedding, or vector representation, of the training audio event identifier are processed through layers of the encoder-decoder network with the output being a modified audio spectrogram. The modified audio spectrogram is a representation of the training audio sequence that includes only the audio event indicated by the training audio event identifier.

As illustrated in FIG. 10, the method 1000 includes an act 1006 of generating an output using the modified audio spectrogram. In some embodiments, the modified audio spectrogram can be converted to an audio waveform using an inverse STFT and provided as an output. In other embodiments, the modified audio spectrogram can be sent to a post-processing network. The post-processing network can be a neural network trained to generate an enhanced audio sequence using the modified audio spectrogram and the training audio event identifier. In such embodiments, the enhanced audio sequence can then be provided as an output.

As illustrated in FIG. 10, the method 1000 includes an act 1008 of calculating a loss using the generated output the ground truth separated audio sequence. In one or more embodiments, the loss is calculated using a multi-resolution STFT magnitude loss, L_{mstft}, a mel-spectrogram loss, Lₘₑₗ, and a time-domain L2 loss, Lₜᵢₘₑ, which can be expressed as follows:

$${L}_{mstft} = {\sum }_{i} {‖ log \vert STFT ( y ; {θ}_{i} ) \vert - log \vert STFT ( {y}^{′} ; {θ}_{i} ) \vert ‖}_{1}$$

$${L}_{mel} = {\sum }_{i} {‖ log Mel ( y ) - log Mel {y}^{′} ‖}_{1}$$

$${L}_{time} = {\sum }_{i} {‖ y - {y}^{′} ‖}_{1}$$

In one or more embodiments, to further enhance the perceptual quality of the separation, the loss is further calculated by integrating adversarial training with three types of audio discriminators: a multi-resolution STFT discriminator with five NFFT sizes (e.g., 256, 512, 1024, 2048, 4096), a multi-scale discriminator with four resolutions (e.g., 1, 2, 4, 10), and a multi-period discriminator with five periods (e.g., 2, 3, 5, 9, 11). In embodiments, the hinge version of the adversarial loss is used. Additionally, a feature matching loss, L_{FM}, can be adopted to enforce the generator to predict sources that match the target sources in the feature space of the discriminators. These losses can be expressed as follows:

$${L}_{adv} = - D ( {y}^{′} ) ; {L}_{D} = {[ 1 - D ( y ) ]}^{+} + {[ 1 + D ( {y}^{′} ) ]}^{+}$$

$${L}_{FM} = {\sum }_{i = 1}^{M} [ \frac{1}{{N}_{i}} {‖ {D}^{i} ( y ) - {D}^{i} ( {y}^{′} ) ‖}_{1} ]$$

where M is the number of layers in the discriminator, D, excluding the output layer, and Nᵢ is the number of units in the i-th layer of D. In summary, the total loss on the generator can then be expressed as:

$${L}_{G} = {L}_{time} + {λ}_{mstft} {L}_{mstft} + {λ}_{mel} {L}_{mel} + {λ}_{adv} {L}_{adv} + {λ}_{FM} {L}_{FM}$$

where λ's denote the scales for fusing different loss functions. In one or more embodiments, λ_{mstft}=0.01, λₘₑₗ=0.01, λ_{adv}=1, and λ_{FM}=10 for training single-class and multi-class models.

As illustrated in FIG. 10, the method 1000 includes an act 1010 of training the machine learning models using the calculated loss. In one or more embodiments, the calculated loss is backpropagated to the encoder-decoder network and the post-processing network.

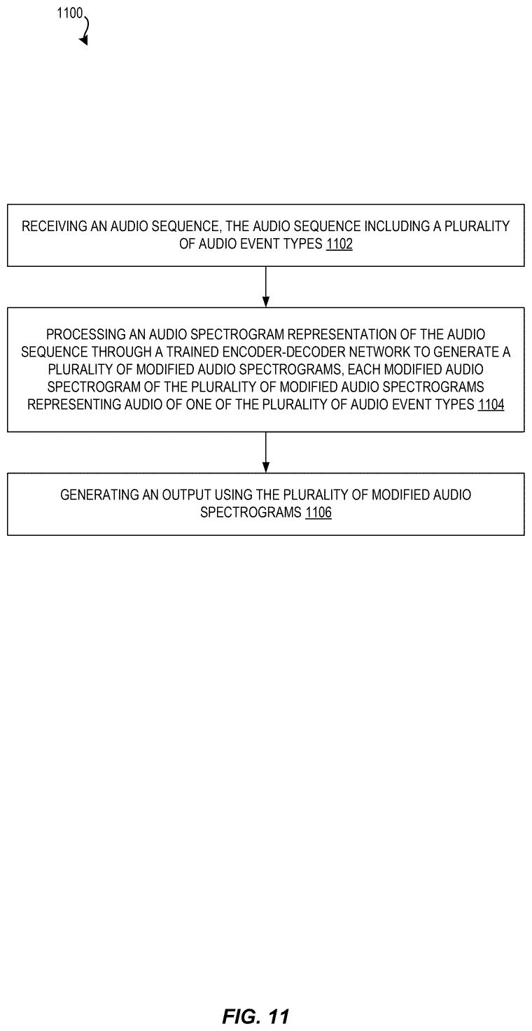

FIG. 11 illustrates a flowchart of a series of acts in a method of performing multi-event separation of audio events from an audio sequence in accordance with one or more embodiments. In one or more embodiments, the method 1100 is performed in a digital medium environment that includes the audio separation system 800. The method 1100 is intended to be illustrative of one or more methods in accordance with the present disclosure and is not intended to limit potential embodiments. Alternative embodiments can include additional, fewer, or different steps than those articulated in FIG. 11.

As illustrated in FIG. 11, the method 1100 includes an act 1102 of receiving an audio sequence, the audio sequence including a plurality of audio event types. In one or more embodiments, an audio separation system (e.g., audio separation system 800) receives an input that includes an audio sequence. The audio separation system is trained to separate one or more audio events from the audio sequence, where the audio event types to be separated are based on the training data used for training. The audio event types can include speech and non-speech audio events. In one embodiment, example non-speech audio event types include alarm, applause, birds, coughing, crying, engine, laughter, pets, traffic, and typing. Other types of non-speech audio event types can include reverberation, ambient noise, and music. Other embodiments can include fewer, additional, and/or different audio event types.

As illustrated in FIG. 11, the method 1100 includes an act 1104 of processing an audio spectrogram representation of the audio sequence through a trained encoder-decoder network to generate a plurality of modified audio spectrograms, each modified audio spectrogram of the plurality of modified audio spectrograms representing audio of one of the plurality of audio event types. In one or more embodiments, the audio separation system generates the audio spectrogram from the audio sequence using a short-time Fourier transform (STFT). The trained encoder-decoder network then receives the audio spectrogram. In one or more embodiments, the encoder-decoder network is a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

The encoder-decoder network generates the plurality of modified audio spectrograms, where each modified audio spectrogram is a representation of the audio sequence that includes only one of a plurality of audio event types the encoder-decoder network is trained to predict. In one or more embodiments, if the audio sequence does not include audio of a particular audio event type the encoder-decoder network is trained to predict, the corresponding modified audio spectrogram for the audio event type will not include any data.

As illustrated in FIG. 11, the method 1100 includes an act 1106 of generating an output using the plurality of modified audio spectrograms. In some embodiments, the plurality of modified audio spectrograms can be converted to separate audio waveforms using an inverse STFT and then provided as an output. In one or more embodiments, where the modified audio spectrogram for an audio event type does not include any data, the corresponding audio waveform will be empty (e.g., a silent track).

In other embodiments, the first modified audio spectrograms can be sent to a post-processing network. In one or more embodiments, the post-processing network is a neural network trained to generate enhanced audio spectrograms from the modified audio spectrograms. An exemplary post-processing network can include a two-dimensional CNN layer and two TFC-TDF modules. In some embodiments, enhanced audio sequences are generated by converting the plurality of enhanced audio spectrograms to audio waveforms using an inverse STFT. Similarly to the output of the encoder-decoder network, where the enhanced audio spectrogram for an audio event type does not include any data, the corresponding audio waveform will be empty (e.g., a silent track). In embodiments, the enhanced audio sequences can then be provided as the output.

In one or more embodiments, each of the enhanced audio sequences can include separated audio from one of a plurality of audio categories defined by the training data used to the train the audio separation system. In one example, the audio separation system can generate an output that includes three tracks: speech audio, music audio, and ambient noise audio. The ambient noise audio can include the non-speech audio events, that are not speech or music, that the audio separation system is trained to predict. In one or more embodiments, the audio separation system can further output a remainder audio sequence that is the reverberation or reverberated sound of the audio sequence. In such embodiments, the remainder audio sequence can be generated by subtracting the speech audio, the music audio, and the ambient noise audio from the audio sequence. In other embodiments, the remainder audio sequence can include additional or different audio (e.g., non-speech audio events the audio separation system has not been trained to separate). For example, the remainder audio sequence can be an ambient noise audio generated by subtracting the speech audio and the background music audio from the audio sequence, or the remainder audio sequence can be a mixture of the audio events in audio sequence that were excluded from the plurality of audio event types the audio separation system is trained to separate.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates, in block diagram form, an exemplary computing device 1200 that may be configured to perform one or more of the processes described above. One will appreciate that one or more computing devices such as the computing device 1200 may implement the audio separation system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example, and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving an audio sequence and a first audio event identifier, the first audio event identifier indicating a requested first audio event type of a plurality of audio event types;
processing an audio spectrogram representation of the audio sequence through a trained encoder-decoder network to generate a first modified audio spectrogram, the first modified audio spectrogram representing audio of the requested first audio event type; and
generating an output using the first modified audio spectrogram.

2. The method of claim 1, wherein processing the audio spectrogram representation of the audio sequence through the trained encoder-decoder network to generate the first modified audio spectrogram further comprises:
passing a vector representation of the first audio event identifier through layers of the trained encoder-decoder network.

3. The method of claim 1, wherein generating the output using the first modified audio spectrogram further comprising:
generating, by a post-processing network, an enhanced audio sequence including the audio of the requested first audio event type using the first modified audio spectrogram and the first audio event identifier; and
providing the enhanced audio sequence as the output.

4. The method of claim 1, wherein generating the output using the first modified audio spectrogram further comprises:
displaying a graphical user interface indicating a plurality of modified audio spectrograms, including the first modified audio spectrogram, wherein each modified audio spectrogram of the plurality of modified audio spectrograms is associated with a different audio event type of the plurality of audio event types;
receiving, via the graphical user interface, a selection of one or more of the plurality of modified audio spectrograms;
generating a modified audio sequence that includes the selected one or more of the plurality of modified audio spectrograms; and
providing the modified audio sequence as the output.

5. The method of claim 1, wherein generating the output using the first modified audio spectrogram comprises:
generating the output to include a plurality of audio tracks, wherein each audio track of the plurality of audio tracks corresponds to one of a plurality of audio event identifiers, including the generated output corresponding to the first audio event identifier.

6. The method of claim 5, further comprising:
combining the plurality of audio tracks into a plurality of audio categories, wherein the plurality of audio categories includes one or more of: speech audio, non-speech audio, music audio, ambient noise audio, and stationary noise audio; and
generating a remainder audio sequence, wherein the remainder audio sequence is one of: reverberation generated by subtracting the speech audio, the music audio, and the ambient noise audio from the audio sequence, ambient noise generated by subtracting the speech audio and the music audio from the audio sequence, and a mixture of audio events excluded from the plurality of audio event types.

7. The method of claim 5, wherein the audio sequence is a multi-channel audio sequence, and wherein inter-channel relationships between channels of each audio track of the plurality of audio tracks are maintained.

8. A non-transitory computer-readable medium storing executable instructions, which when executed by a processing device, cause the processing device to perform operations comprising:
receiving an audio sequence and a first audio event identifier, the first audio event identifier indicating a requested first audio event type of a plurality of audio event types;
processing an audio spectrogram representation of the audio sequence through a trained encoder-decoder network to generate a first modified audio spectrogram, the first modified audio spectrogram representing audio of the requested first audio event type; and
generating an output using the first modified audio spectrogram.

9. The non-transitory computer-readable medium of claim 8, wherein the instructions to process the audio spectrogram representation of the audio sequence through the trained encoder-decoder network to generate the first modified audio spectrogram further comprise:
passing a vector representation of the first audio event identifier through layers of the trained encoder-decoder network.

10. The non-transitory computer-readable medium of claim 9, wherein the instructions to generate the output using the first modified audio spectrogram further comprise:
generating, by a post-processing network, an enhanced audio sequence including the audio of the requested first audio event type using the first modified audio spectrogram and the first audio event identifier; and
providing the enhanced audio sequence as the output.

11. The non-transitory computer-readable medium of claim 8, wherein the instructions to generate the output using the first modified audio spectrogram further comprise:
displaying a graphical user interface indicating a plurality of modified audio spectrograms, including the first modified audio spectrogram, wherein each modified audio spectrogram of the plurality of modified audio spectrograms is associated with a different audio event type of the plurality of audio event types;
receiving, via the graphical user interface, a selection of one or more of the plurality of modified audio spectrograms;
generating a modified audio sequence that includes the selected one or more of the plurality of modified audio spectrograms; and
providing the modified audio sequence as the output.

12. The non-transitory computer-readable medium of claim 8, wherein the instructions to generate the output using the first modified audio spectrogram further comprise:
generating the output to include a plurality of audio tracks, wherein each audio track of the plurality of audio tracks is associated with one of a plurality of audio categories, wherein the plurality of audio tracks includes one or more of: a speech audio track, a non-speech audio track, a music audio track, a stationary noise audio track, and an ambient noise audio track, wherein one of the plurality of audio tracks includes the generated output corresponding to the first audio event identifier.

13. The non-transitory computer-readable medium of claim 12, further comprising:
combining the plurality of audio tracks into a plurality of audio categories, wherein the plurality of audio categories includes one or more of: speech audio, non-speech audio, music audio, ambient noise audio, and stationary noise audio; and
generating a remainder audio sequence, wherein the remainder audio sequence is one of: reverberation generated by subtracting the speech audio, the music audio, and the ambient noise audio from the audio sequence, ambient noise generated by subtracting the speech audio and the music audio from the audio sequence, and a mixture of audio events excluded from the plurality of audio event types.

14. The non-transitory computer-readable medium of claim 12, wherein the audio sequence is a multi-channel audio sequence, and wherein inter-channel relationships between channels of each audio track of the plurality of audio tracks are maintained.

15. A system comprising:
a memory component; and
a processing device coupled to the memory component, the processing device to perform operations comprising:
receiving an audio sequence, the audio sequence including a plurality of audio event types;
processing an audio spectrogram representation of the audio sequence through a trained encoder-decoder network to generate a plurality of modified audio spectrograms, each modified audio spectrogram of the plurality of modified audio spectrograms representing audio of one of the plurality of audio event types; and
generating an output using the plurality of modified audio spectrograms.

16. The system of claim 15, wherein the operations of generating the output using the plurality of modified audio spectrograms further comprise:
generating, by a post-processing network, a plurality of enhanced audio sequences using the plurality of modified audio spectrograms; and
providing the plurality of enhanced audio sequences as the output.

17. The system of claim 16, wherein each enhanced audio sequence of the plurality of enhanced audio sequences includes separated audio from the audio sequence associated with one of a plurality of audio categories.

18. The system of claim 17, wherein the operations further comprise:
generating a remainder audio sequence, wherein the remainder audio sequence is one of: reverberation generated by subtracting a speech audio track, a music audio track, and an ambient noise audio track from the audio sequence, ambient noise generated by subtracting the speech audio track and the music audio track from the audio sequence, and a mixture of audio events excluded from the plurality of audio event types.

19. The system of claim 18, wherein the operations further comprise:
displaying a graphical user interface indicating the enhanced audio sequences and the remainder audio sequence;
receiving, via the graphical user interface, a selection of an amount of the remainder audio sequence to include in a final output audio mixture;
generating the final output audio mixture based on the received selection; and
providing the final output audio mixture as the output.

20. The system of claim 17, wherein the audio sequence is a multi-channel audio sequence, and wherein inter-channel relationships between channels of each audio track of the plurality of enhanced audio sequences are maintained.
